(19) United States
(12) Patent Application Publication
(10) Pub. No.: US 2004/0031025 A1
(43) Pub. Date: Feb. 12, 2004

(54) Formal verification in particular of a secure virtual machine

(76) Inventor: Pascal Brisset, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/432,248

(22) PCT Filed: Nov. 21, 2001
(86) PCT No.: PCT/FR01/03656

(30) Foreign Application Priority Data
Nov. 24, 2000 (FR) 00/15306

(51) Int. Cl. G06F 9/45; G06F 9/44; G06F 17/00

(52) U.S. Cl. 717/154; 717/118; 717/126; 717/139; 718/1

(57) ABSTRACT

The invention concerns formal verification and optimization of a program, typically of a virtual machine, initially written in high-level language and implanted for example in a smart card. During verification, it is formally proved (E4) that checks on program states explored by security mechanisms guarantee that a specific forbidden state defined in a high-level language is unreachable by the program. The implantation of the program is then optimised in particular by eliminating execution paths leading to the forbidden state in the program, so as to transform it into a program in a low-level language providing the same security guarantees as the high-level language program.

The present invention relates to the verification of a program initially written in a high-level language, during its implementation in a secure environment and thus linked to security mechanisms checking possible states of the program.

For example, the program is an interpreter or a virtual machine installed in a smart card or a portable radiotelephone terminal.

In global applications linked with the Internet network, the publishers of computer tools, especially of browsers, have been constrained to adopt a common high-level language, such as the object-oriented language known as Java (registered trademark), for the distributed programming of communications between small local programs and servers.

The search for ever more numerous and flexible functionalities, in particular security functionalities, in respect of objects on the move, such as mobile radiotelephones, payment cards and personal digital assistants, has led to the microcontrollers included in smart cards and similar data processing means being furnished with relatively comprehensive languages such as the Java language.

The universality, in the variety of devices connected to the largest of networks just as in the varieties of ever smaller appliances, emanating from an innumerable multiplicity of manufacturers, of different hardware architectures, of diverse computer systems, within very diverse constraints, is an obstacle to a single, unambiguously interpreted language.

For these reasons a virtual machine capable of executing all the programs written in the Java language has been defined. The suppliers of hardware in particular of smart cards, or the publishers of softwares in particular of Web browsers, have then had to develop, on the tools which they supply, software capable of carrying out the functions of this virtual machine, customarily called a <<Java virtual machine>> JVM, specific to each software or hardware tool. On account of the small size of the memory in smart cards, this software then called <<JavaCard>> has been <<streamlined>>.

In contradistinction to <<bare>> processors, the objective of which is first and foremost computational or low consumption performance, the Java virtual machine has been designed to provide developers with security functions suitable for sensitive uses especially in the field of electronic banking and security.

On the other hand, the execution of a Java program is not in fact totally safe unless the JVM machine has been correctly implemented in respect of all the critical security functions.

The ITSEC (Information Technology Security Evaluation Criteria) standards of the Commission of the European Communities advise in respect of the analysis of the security of computer systems:

that security objectives be fixed;

that a security policy be deduced therefrom, the application of which will make it possible to achieve the security objectives;

that security functions be defined, the execution of which guarantees that the security policy is complied with;

that security mechanisms which are the hardware or software implementation of the security functions be designed.

It is therefore important to the end-user clients that the JVM machine conforms to the security policy that the nature of the application, for example in the field of electronic banking or mobile radiotelephony, imposes on the operators, such as banks or telecommunication operators.

Within this context, it is in the interests of a supplier of the JVM machine supported by a data processing means to demonstrate that its implementation conforms to a security policy that his client, operator or bank, will have contractually defined to him, or to the policy that the law or regulations impose.

It will therefore be necessary to verify that this or that security flaw does not exist, whatever Java program is executed by the JVM machine, and whatever the environment of the data processing means, such as a processor, which runs the JVM machine. One is therefore dealing with a complex and tricky process, with profound economic implications.

Such verification relies on formal techniques which are a set of software or methodological tools, which definitely guarantee software properties. In the course of the process of developing a program, for example an interpreter, on this occasion a virtual machine, these formal techniques employ mathematical approaches which deliver these guarantees. Numerous techniques are available, each having its specific features.

For reasons of efficiency, some of the checks performed by the virtual machine are static, such as the semantic analysis of a program before it is run. Since the algorithms brought into play are complex, it is difficult to design and to install, that is to say implement a virtual machine. Verification that a Java virtual machine does indeed comply with a sought-after security policy necessarily involves, in respect of some properties, the joint use of several techniques, formalisms, languages, which structure the development.

More particularly, the invention relates to a method of verification which guarantees that the specification of a virtual machine is correct and unambiguous, and that installation thereof is safe. This entails formally verifying the correctness of the static checks and of their installation.

The object of the invention is to optimize the installation of a high-level language program interpreter, such as a virtual machine whose security mechanisms, comprising for example static checks, have been formally verified in conformity with a security function specification.

Accordingly, a method for verifying and optimizing a program initially written in a high-level language and installed in a data processing means, in the course of which checks on program states explored by security mechanisms prove formally that a forbidden state defined in a high-level language is unreachable by the program, is characterized by an elimination of execution paths leading to the forbidden state in the program, in such a way as to transform the program into an equivalent program in a low-level language. The latter provides thus the same security guarantees as the program in the high-level language.

Installation as a high-level language is thus transformed into optimized installation in a low-level language by manual or automatic application of local transformation rules to the high-level source code. The simplicity and the systematic nature of these rules guarantees semi-formally or formally the correctness of the low-level language optimized installation as compared with the high-level installation, and by transitivity, as compared with specifications of the security mechanisms.

According to other characteristics of the invention, the optimization of the program, such an interpreter or a virtual machine, can comprise further, a replacement of unbounded integers of the high-level language by bounded integers of the low-level language and/or a replacement of parameters and of function calls in the high-level language by statically allocated data and imperative control structures in the low-level language.

The method of verification according to the invention can be applied to a program of the known virtual machine type comprising integer data, tables, pointers to the tables, reusable local variables or registers, exceptions, subroutines, or an operand stack. The instruction set of the virtual machine comprises arithmetic operations, those for accessing the variables, for accessing the tables, for manipulating the stack, test operations, jump operations, subroutine call and return operations, exception throwing operations.

The static checks guarantee compliance with operand typing constraints, with constraints on the control flow, with operand stack non-overflow constraints, and with constraints on the use of local variables.

Other characteristics and advantages of the present invention will become more clearly apparent on reading the following description of several preferred embodiments of the invention with reference to the corresponding appended drawings in which:

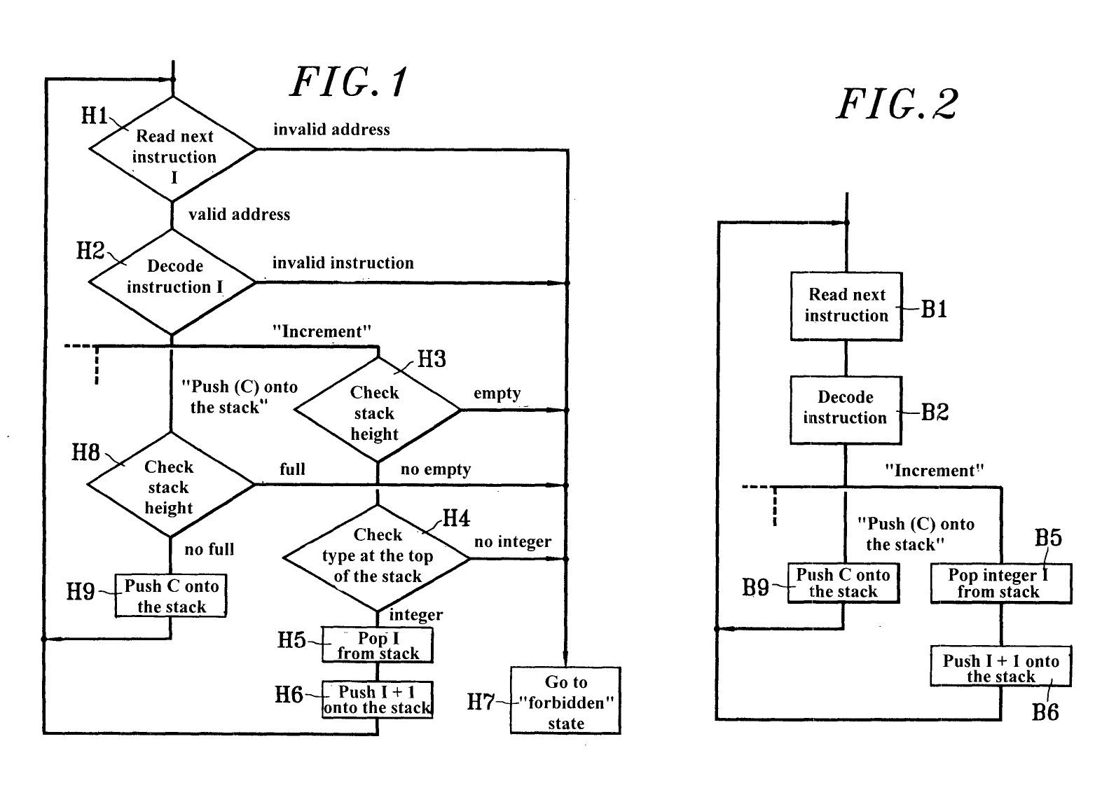

FIG. 1 is a high-level language interpreter algorithm with dynamic checks;

FIG. 2 is a low-level language optimized interpreter algorithm; and

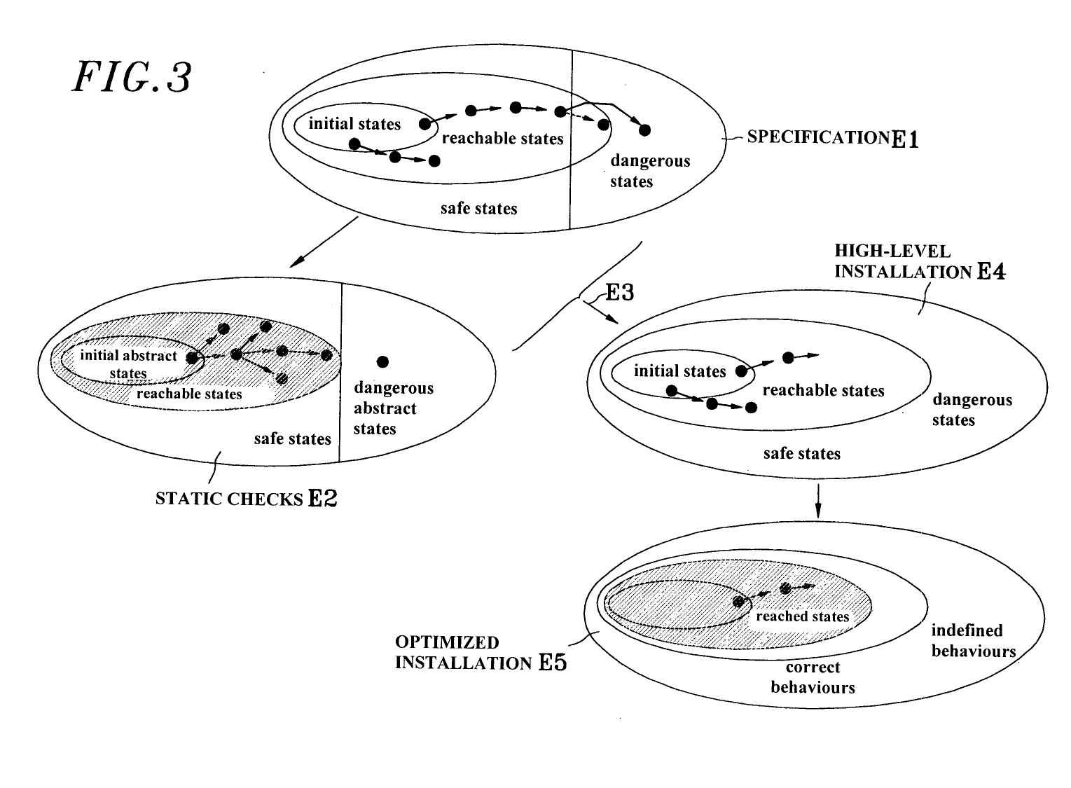

FIG. 3 diagrammatically illustrates a method of virtual machine formal verification culminating in optimization according to the invention.

By way of example, reference is made to a program of interpreter type constituting the execution engine of a virtual machine installed in a data processing means, the so-called execution platform, such as the microcontroller of a mobile radiotelephone terminal, or of a smart card such as a payment card or a SIM (Subscriber Identity Module) identity card. The interpreter implemented automatically on the basis of formal specifications and written in a high-level source language so as to execute an instruction as shown in FIG. 1, is to be optimized according to the invention as a low-level language shown in FIG. 2. For example, the high-level source language is a language from the ML family, such as the CAML language developed by the INRIA in France, and the low-level language is the imperative C language.

The installation of the interpreter (interp) in a high-level language is achieved through an automatic method on the basis of formal specifications written in a language based on mathematical logic, thereby ensuring its conformity to these specifications. It comprises the following control structure:

```
  let interp m st =
  match (nth st.pc m.code) with
  |None->Forbidden
  |Some Illegal->Forbidden
  |Some Iadd->
  (match st.stack with
  |Cons(Vint x,Cons(Vint y,stack'))->Continue [...]
  |_-> Forbidden
[...]
```

This control structure carries out the following functions with reference to steps H1 to H7 of FIG. 1.

In step H1, during an attempt to read the current instruction I designated by the ordinal counter (st.pc) in a state (st) for a program (m.code), the value of the execution address corresponding to the current instruction is checked (match (nth st.pc m.code)). If the address is invalidated because it does not belong to the program (None) or designates an incorrect instruction (Some Illegal), control passes to a <<forbidden>> state in step H7 where it is halted. Otherwise, in the next step H2, the current instruction I pointed at by the validated execution address is checked.

For example, the instruction validated in step H2 may be the add instruction (Iadd). In this case, in the next steps H3 and H4 which may be combined, the operands to which the add instruction is applied are checked. In this instance, if the top of the operand stack contains at least two values and if these two values (Cons value 1 (Cons value 2 stack′)) are of integer type (Vint), that is to say if the add is coherent, execution continues normally (Continue), by popping the values from the stack in step H5, by pushing their sum onto the stack in step H6, and by incrementing the ordinal counter and recursively calling the interpreter (interp m st′) with regard to a new state (st′) so as to return to step H1. On the other hand, if the current instruction is. Iadd while there is an insufficient number of operands or they are not of the right type, control passes to the forbidden state and is halted in step H7.

According to another variant also shown in FIG. 1, when the current instruction is the instruction to push a constant value C onto the stack, the control structure comprises steps H8 and H9. Step H8 checks the height of the operand stack and, if the stack is not full, step H9 pushes the value C at the top of the stack. On the other hand, if the stack is full, the control structure goes to the forbidden state in step H7.

In FIG. 1, the control structure comprises three execution paths emanating from steps H1, H2 and (H3, H4), or from steps H1, H2 and H8, which correspond to failed checks and which culminate in the forbidden state in step H7.

With reference now to FIG. 2, the low-level C language interpreter after optimization according to the invention applied to the high-level ML language interpreter now comprises only the process steps B1, B2, B5, B6 and B9 corresponding respectively to steps H1, H2, H5, H6 and H9, without the dynamic checking steps H3-H4 and H8 and especially without the forbidden state step H7.

```
  The low-level C language optimized control
structure may be written:
switch (code[pc]){
  case IADD:stack[top+1]+=stack[top];++top;++pc;break;
  [...]
}
```

where the conditional analysis instruction (switch) is read in step B1 so as to decode the next instruction (case) associated with the value (pc) in step B2 and designating the add instruction (IADD) for adding two integer values with addresses (top+1) and (top) to be popped from the stack in step B5.

This low-level source code is at one and the same time efficient since it does not comprise any unnecessary dynamic checks and is safe since it is derived directly from a source code whose correctness has been proven formally according to the invention, as will be seen hereinafter.

When compared with FIG. 1, the execution paths culminating in the forbidden state of step H7 are eliminated from the source code of the interpreter in FIG. 2, this corresponding to the following optimizations:

elimination of check on the execution address in step H1 corresponding to step B1;

elimination of the check and of the type of the arguments to which the add operation is applied in steps H3 and H4;

simplification of the machine representation of the data, their type no longer being represented.

These optimizations applied to the ML high-level source code hereinabove lead, through the application of simple and local transformations, either manually or through the use of an automatic tool, to an optimized source code in a low-level language, on this occasion the C language.

The method of the invention comprises the obtaining of a formal proof of the effectiveness of the mechanisms for static checking of the virtual machine. Stated otherwise, if these mechanisms have permitted the execution of a given program (code), then the execution of this program by the interpreter (interp) will never culminate in the forbidden state. This guarantee is obtained in the course of the subsequent steps E1 to E5 shown in FIG. 3.

In step E1, a logical language for specifying the virtual machine which is a variant of the theory of types makes it possible to describe and to reason with regard to data structures and algorithms in a program. Predetermined security mechanisms, such as static checks (incorrect instruction or execution address; step H1 or H2), are specified as a flow analysis problem for the possible execution states, or variants, of the program implementing the interpreter, in a manner similar to the analysis of the behaviors of a symbolic object. Security functions typically comprise checks of typing, of access to data, of access to operations, and of access to resources. If certain states reachable by executing the program from their initial states become dangerous, these states are returned through transitions to a forbidden state (step H7), and the other states are presumed to be safe.

In step E2, security mechanisms are obtained from among the predetermined security mechanisms by reformulating the flow analysis problem as the combination of an abstraction problem and of a problem of exhaustive exploration of a system having states and transitions. If there exists an infinite number of program execution states, this infinite number is reduced to a finite number of reachable abstract states of the program which are explored by the static checks. The static checks verify that the <<forbidden>> abstract state is unreachable by the program thus defined so as to preserve the program's security properties.

Step E3 consists in going from steps E1 and E2 to a step E4, that is to say in specifying the virtual machine interpreter so that it comprises assertions, for example the validations of addresses or of instructions in steps H1, H2 and the checks in the step H3-H4 for checking integer operands. These assertions express a security policy, as well as a so-called forbidden state (step H7) which is reached whenever an assertion fails.

The interpreter and its security mechanisms are installed in a high-level language of the ML type, for example the CAML language according to the example hereinabove and FIG. 1, or the SML language, on the basis of specifications of the virtual machine and with the aid of a logic-based tool. This installation in step E4 comprises dynamic checks corresponding to the assertions, which dynamic checks return the dangerous states of the program to the forbidden state. In the course of step E4, it is proven with the aid of the logic-based tool that if the mechanisms have permitted the execution of a program, then its execution by the interpreter will never culminate in the forbidden state.

Next, according to the invention, step E5 optimizes the interpreter of the virtual machine by applying three subsequent local transformations to the ML language source code. These transformations are carried out manually by a programmer, although in a variant at least some of them may be carried out automatically by appropriate programming tools.

E51) A first transformation is an elimination of the execution paths, for example between steps H1, H2, H3, H4 and step H7, which definitely lead to the forbidden state. This elimination is guaranteed by the static checks which have ensured that no state reachable by the interpreter is dangerous. Furthermore, the static checks justify the simplification of the machine representation of the data, the elimination of index overflow tests, and the elimination of tests on the ordinal instruction counter, as shown by the comparison of FIGS. 1 and 2.

E52) A second transformation is a replacement of the infinite, that is to say unbounded, integer types of the high-level language by bounded integer types, that is to say finite binary integers, in the low-level C language. This replacement is performed according to a first variant, when it has been formally proven that predetermined bounds cannot be reached by integer variables of the high-level language which are processed by the interpreter. According to a second variant, this replacement is performed when the operations applied to these integer variables are such that the bounds cannot be reached by the integer variables in the high-level language before the expiry of a predetermined time span less than the life span of the virtual machine; for example this second variant is applied when the only operations are incrementations and decrementations relating to a small initial value.

E53) A third transformation is a replacement of the so-called <<tail-recursive>> function calls and of their arguments in the high-level language by imperative control structures in the low-level language and statically allocated data. For example, the tail-recursive calls of the interpreter (interp) are replaced by an imperative loop, and its argument (st) representing the state of the program is replaced by statically allocated data, including among other things the operand stack (stack) and the ordinal counter (pc) in the low-level language example.

The field of application of the verification method of the invention relates in particular to smart cards for electronic banking or for security access, and most especially to downloadable smart cards whose executed code is not known a priori. The smart cards may be included in devices whose programming is accessible to third parties, in particular for mobile radiotelephony applications, and most especially Wap telephone applications mixing both the Internet and mobile aspects.

1. Method for verifying and optimizing a program initially written in a high-level language and installed in a data processing means, in the course of which checks (H1, H2, H3-H4) on program states explored (E1-E2) by security mechanisms prove formally (E4) that a forbidden state (H7) defined in a high-level language is unreachable by the program, characterized by an elimination of execution paths (H1-H7, H2-H7, H3-H4-H7) leading to the forbidden state in the program, in such a way as to transform the program into an equivalent program in a low-level language.

2. Method in accordance with claim 1, comprising a replacement of unbounded integers of the high-level language by bounded integers of the low-level language.

3. Method in accordance with claim 2, wherein said replacement is performed when it has been formally proven that predetermined bounds of the integers of the high-level language cannot be reached.

4. Method in accordance with claim 2, wherein said replacement is performed when predetermined bounds cannot be reached by the integers in the high-level language before the expiry of a predetermined duration.

5. Method in accordance with any one of claims 1 to 4, comprising a replacement of parameters and of function calls in the high-level language by statically allocated data and imperative control structures in the low-level language.
